(19) United States
(12) Patent Application Publication
(10) Pub. No.: US 2002/0038923 A1
(43) Pub. Date: Apr. 4, 2002

(54) Process for manufacturing components of fibre-reinforced plastics

(75) Inventor: Otto Lenherr, Roggwil (CH)

Correspondence Address: Klaus P. Stoffel, Esq., Cohen, Pontani, Lieberman & Pavane, Suite 1210, 551 Fifth Avenue, New York, NY, 10176, US

(73) Assignee: Alcan Technology & Management Ltd.

(21) Appl. No.: 09/971,721

(22) Filed: Oct. 4, 2001

(30) Foreign Application Priority Data
Oct. 4, 2000 (EP) 00810918.3

(51) Int. Cl. B29C 33/40; B29C 33/76

(52) U.S. Cl. 264/221; 264/257; 264/317; 425/86; 425/217

(57) ABSTRACT

The invention relates to a Resin Transfer Moulding (RTM) process for manufacturing fiber-reinforced components (31) with at least one closed or undercut space (35). A two-part mould with a cavity is charged with reinforcing fibers and a shape-stable supporting core of wax that can be melted out of the cavity. The core is produced from a cast preform by means of at least one shape-forming step. A plastic matrix capable of flowing is injected into the cavity of the closed mould forming a shaped fiber-composite mass and hardened to give the fiber-reinforced component (31). The shape-stable fiber-reinforced component (31) is removed from the mould and subjected to tempering. During tempering the core is melted and drained off from the fiber-reinforced component—leaving behind a closed or undercut space (35)—and the molten core material is cast to provide a new preform (1).

The present invention relates to a for manufacturing single part fibre-reinforced components having at least one closed or undercut space, in particular a resin-flow moulding resp. a Resin Transfer Moulding (RTM) process, whereby a shape-stable supporting core (hereinafter simply core) to create the hollow space in the fibre-reinforced component is manufactured and a mould with a cavity is charged at least with fibre material and the core, and a plastic matrix capable of flowing is injected into the cavity of the closed mould forming a shaped fibre-composite mass soaked in plastic matrix, and the fibre-composite mass is hardened resulting in a fibre-reinforced component. Further, the invention also concerns the production of the core and a device for carrying out the process according to the invention as well as fibre-reinforced components manufactured using the process according to the invention.

Fibre-reinforced components resp. fibre composite components are parts made out of fibre-reinforced plastics. They have gained increasing importance because of their relatively light weight and the high strength due to incorporation of fibres in them, this in particular in road and railway vehicles, aircraft construction, aerospace, structures or light weight structures e.g. for reinforcing purposes, or in sports equipment. Fibre-reinforced components also find increasing use as load-bearing structural components in the above fields, whereby such fibre-reinforced components often exhibit extremely complex three-dimensional geometric shapes.

The production of fibre-reinforced components is very often based on the following principles: reinforcing fibres which are e.g. in the form of fibre structures, hereinafter referred to as fibre preforms, are impregnated with components capable of flow, in particular plastics which are capable of flow, hereinafter plastic matrix. The reinforcing fibres embedded in a plastic matrix, hereinafter fibre-reinforced mass, is subjected to a shaping process and hardened normally under the influence of heat and/or pressure.

A known manufacturing process is e.g. the so called Resin-Transfer-Moulding process (RTM process), such as is described e.g. by Köfte in “Der Resin-Transfer-Moulding Prozess”, Publisher TÜV Rheinland, 1991, pp 3-16.

In the RTM process at least fibre-reinforcing, in particular in the form of fibre structures, and as required further components, are placed in the cavity of an open multi-part mould. In a subsequent step a duroplastic or thermoplastic matrix is injected into the cavity of the closed mould thus forming a fibre-reinforced mass. In a final step the fibre-reinforced mass is hardened or polymerised and the stable-shaped fibre-reinforced component removed from the mould.

In the meantime, thermoplastics and duroplastic resins are also employed in the RTM process, for which reason the term “RTM Process” should also be understood in the following as the expression for the process described—independent of the plastic matrix employed.

The RTM process enables series production of single part fibre-reinforced components of complex three dimensional shape, whereby the term single part component is to be understood to represent a component which is manufactured as one piece and not as a component which has been joined together. As a result of the RTM process it is possible to manufacture in particular fibre-reinforced components in series with a sandwich-type structure i.e. the fibre-reinforced components contain a reinforcing core e.g. in the form of a foamed part.

While the sandwich-type structure has already been well developed in the RTM process, and has found wide application, the series-scale production of single part, reproducible fibre-reinforced components with closed or undercut spaces continue to suffer from manufacturing problems, in particular if the fibre-reinforced components have to meet close tolerance limits. For that reason, reinforcing cores i.e. sandwich-type structures fail to be employed, not for structural reasons but because of manufacturing difficulties, with the result that the fibre-reinforced component is too heavy and because of the cost of manufacturing such reinforcing cores.

Today, three dimensional fibre-reinforced components featuring hollow spaces are usually manufactured using two parts which are joined together i.e. two separate fibre-reinforced components are produced e.g. in an RTM process in the form of two shell halves which are then joined to make up the complete fibre-reinforced component using welding or adhesive bonding methods.

Such joined fibre-reinforced components, however, exhibit visible and therefore undesirable seams, and the appearance of the component can be improved only by means of expensive finishing operations. Furthermore, such seams represent structural weaknesses i.e. they tend to lead to cracks e.g. due to ageing and loading.

The object of the present invention is, therefore, to provide a cost-favourable process, in particular an RTM process, for series production of fibre-reinforced components of high quality, low mass and close tolerances exhibiting at least one closed or undercut space.

That objective is achieved by way of the process according to the invention in which the core is a shaped part that can be melted out of the component above room temperature and is manufactured by means of plastic deformation from a core mass or preform and, in the process of manufacturing the fibre-reinforced component, the core is melted out of the fibre-reinforced component when the component has reached a stable shape containing a closed or undercut hollow space.

The invention also explicitly concerns a process for manufacturing a core for use in a process, in particular an RTM process, for manufacturing fibre-reinforced components, which is characterised by way of the core which is a shaped part able to be melted out of the component above room temperature and is made from a core mass or preform by plastic deformation.

In this text the term “closed space” is to be understood to include hollow spaces with relatively small openings such as e.g. openings to run off the melted core material.

By plastic deformation is to be understood in particular the deformation of a solid body below its melting point by applying external forces, in particular pressure, whereby the deformation step effects flow of material. In deforming plastically the body experiences permanent change of shape and does not recover its original shape when the shape forming forces are no longer acting.

The temperature at which the core mass, preform or core melts is usefully at least 50° C., preferably at least 75° C., in particular at least 85° C. and advantageously at least 90° C. and at most 200° C., preferably at most 130° C., in particular at most 120° C. and advantageously at most 110° C., and on reaching the above mentioned temperature of melting changes to a molten, low viscosity condition.

The core to be manufactured is preferably cast in a mould as a preform. The shape of the preform is preferably such that the distances the material has to flow in order to be pressed into the contour of the cavity are as short as possible. The preform is therefore preferably cast in a rough form with respect to the final shape of the core.

The mould may be a closed mould in which the melt is introduced into the mould via an opening for charging the mould. The mould may, furthermore, feature a riser to accommodate excess melt intended to compensate for the shrinkage experienced in the mould as the material charged cools and contracts. Further, the mould may be an open, in particular dish-shaped mould in which the melt forms a free surface which will be a flat surface on the preform. The preform is comprised of or contains metal e.g. aluminium or steel, ceramic materials and, preferably, plastic or reinforced plastic.

Before and/or after plastically deforming the preform into the final core, the preform may be subjected to further processing e.g. chip-forming steps. In further steps the as-cast and if desired worked preform is made into the final core by plastic deformation. The preform is therefore oversized with respect to the mass of final core, or has at least the same mass as the final core.

The average temperature during the plastic deformation of the preform is lower than its temperature of melting and lies in a range suitable for plastic deformation. The preform is usefully formable or plastically formable at a temperature greater than 20° C., preferably greater than 30° C., in particular greater than 40° C. and advantageously greater than 50° C. up to the above mentioned temperature of melting. The core is in particular plastically formable in a temperature range of 50 to 60° C.

The pre-form is usefully plastically formable at an average temperature greater than 20° C., preferably greater than 35° C., in particular greater than 50° C. Further, the above mentioned forming temperature is usefully less than 100° C., preferably less than 80° C. and in particular less than 65° C.

Advantageously, the preform is shaped into a core by press-moulding. The preform is in particular plastically formed in a press-moulding tool with a shape-forming cavity. The preform is e.g. formed in a multi-part, in particular in a two-part tool containing a shape-forming cavity, whereby the preform is placed in the open-tool cavity and pressed into the contour of the cavity by bringing the parts of the tool together and closing the press-moulding tool. The cavity of the tool usefully reproduces the shape of the hollow space to be created in the fibre-reinforced component. The plastic deformation is usefully completed when the press-moulding tool is completely closed.

The shape of the press-moulding tool depends on the shape of the core. The parts of the tool may contain partial cavities which on closing the tool together form a closed press-moulding tool cavity. Further, individual press-moulding tool parts may also feature cavity parts which on closing the press-moulding tool form a closed press-moulding cavity. Further, on closing the press-moulding tool, individual press-moulding tool parts may also be in the form of stems projecting into the cavity.

A preferred version of the process is such that the preform is placed in a two-part open press-moulding tool forming a cavity, whereby the tool parts form partial cavities and the tool cavity as a whole reproduces the hollow space in the fibre-reinforced component to be manufactured. On closing the press-moulding tool and applying pressure, the preform is pressed into the contour of the tool cavity and shaped into the form of a core, whereby with the complete closure of the press-moulding tool the deformation process is finished.

The rate at which the deformation process is carried out i.e. the rate of closing the tool depends on the plastic behaviour or plasticity of the preform is to be selected such that no brittle behaviour arises and crack formation is avoided. The plastic forming of the preform into the shape of the final core may have a duration e.g. of less than a minute.

The plastic deformation or pressure flow forming may be conducted in several steps, whereby the shape-forming steps may comprise pre-pressing the preform e.g. by partially closing the press-moulding tool and subsequently pressing e.g. by completely closing the tool to yield the final shape of the core. The above mentioned ed method of pressure flow forming enables in particular an exact shape of undercut structures to be achieved.

The press-moulding tool or shape endowing shell of the press-moulding tool is e.g. made of a metal or metal alloy such as aluminium or steel, a ceramic material and preferably a plastic or reinforced plastic. The press-moulding tool may feature overspill openings through which, during plastic deformation, excess preform material can flow out and leave the shape forming cavity. The overspill openings may e.g. lead to chambers in particular to a channel situated at the joint between the two halves of the press-moulding tool. The said chambers or channel take up the excess material flowing out of the cavity in the shaping tool.

Further, the press-moulding tool may feature degassing outlets to conduct away trapped air pockets. The degassing outlets are usefully round openings of relatively small diameter e.g. 0.5-3 mm. After all the air has been expelled, the degassing outlets are blocked off with preform material flowing behind it. However, when the next core is being produced, an increasing difference in pressure between the mould interior and the outside atmosphere builds up causing the material blocking the air outlets to be expelled in an explosive manner at a critical positive pressure.

For the production of the core, the press-moulding tool or press-moulding tool cavity is usefully heated to an elevated temperature of e.g. greater than 25° C., preferably greater than 30° C., in particular greater than 35° C. and advantageously greater than 45° C. and less than 75° C., preferably less than 65° C., in particular less than 55° C. The press-moulding tool may feature integrated means for heating it, or may be heated e.g. in an oven before the shape forming process. The optimum temperature to which the tool should be heated depends essentially on the properties of the preform and the cavity in the press-moulding tool and must be determined individually and specific to the process. In general if the temperature of the tool cavity is too low, cracks may form on the surface of the core during the forming process; if the tool cavity is too high, the core remains stuck in the cavity and is difficult to remove.

In a further version of the invention the core may also be manufactured in an extrusion facility in at least one step involving plastic deformation of a core mass. This solution is particularly suitable if the core is a shaped body of uniform cross-section along its whole length. A core manufactured according to the invention may be of any size e.g. from a few centimeters up to some meters. Likewise the shape of the core has no limits. This may be voluminous, be of a given area, be thin or thick, feature undercuts and other types of complex geometrical shapes.

The core is preferably partially and in particular completely or essentially made of wax. The wax is e.g. a natural wax, a wax of plant origin, a wax of animal origin, a mineral wax, petrochemical wax or a chemically modified wax such as hard wax and in particular a synthetic wax such as polyalkylene wax or polyethylene-glycol wax. The cores may also be made of a mixture of different waxes.

Apart from waxes the cores may contain fillers such as e.g. mineral type substances. The filler may be employed e.g. to reduce the extent of shrinkage or to influence the temperature of melting or plasticity. The process described here, however, permits in particular the use of practically pure waxes which exhibit a large degree of shrinkage on solidification, but which have been found by experience to exhibit good run-off melting properties. This means that simply by means of the melting process i.e. without any mechanical aid, the pure waxes can be removed almost completely from the space in the fibre-reinforced component.

After its plastic deformation the core is preferably held at its forming temperature and introduced at that temperature into the shaping tool for the production of the fibre-reinforced component. The core is preferably employed for the production of the fibre-reinforced component immediately after the plastic deformation, with the result that it essentially maintains its forming temperature up to the point at which it is placed in the shaping tool and the plastic matrix is injected into the tool.

The core may also be cooled after plastic deformation, e.g. to a temperature of 15 to 25° C., and reheated e.g. to its shape forming temperature for the production of the fibre-reinforced component.

The production of the fibre-reinforced component is performed using a multi-part, preferably two-part mould. The mould usefully forms a cavity which creates the outer contour of the fibre-reinforced component. The mould, in particular the shape-giving shell of the mould may be of a metal or a metal alloy such as aluminium, steel, chromium, chrome-steel, nickel, and also of Teflon® or Nickel-Teflon®. The mould may also be of plastic or reinforced plastic or a ceramic material. The mould or the wall of the mould cavity is preferably such that it can be heated.

At the start of the process the fibres, the core and if desired further components are placed in the cavity of the open mould.

The reinforcing fibres may be e.g. inorganic fibres such as glass fibres, carbon or graphite fibres such as HT (High Tenacity) fibres, HM (High Modulus) fibres, HST (High Strain and Tenacity) fibres or IM (Intermediate Modulus) fibres, metal fibres (wire), ceramic fibres or fibres of cellulose derivatives, or thermoplastics such as e.g. polyvinyl chlorides, polyacrylonitriles, polyacrylics, polyolefins, e.g. polypropylene, polyesters, polyamides or plastic fibres known as Kevlar® or Aramide etc, or natural fibres such as fibre-like silicate minerals, jute, sisal, hemp, cotton, ramie fibres etc., or fibre mixtures thereof. Especially preferred are glass fibres.

Usefully, the reinforcing fibres are present in the form of structures e.g. in the form of large area textile weaves such as fleeces, non-mesh-forming systems such as gauzes, uniaxial or biaxially oriented layers, networks etc. or mesh-forming systems such as interweaves or mesh-like structures. Preference is given mainly to textile type structures made from directionally oriented fibres and in particular textile type structures made of long fibres having fibre lengths preferably longer than 150 mm, in particular longer than 200 mm, whereby the fibres or rovings are grouped into bundles or strands e.g. 0.1-5 mm in diameter and the bundles of fibres are woven together. The fibre structures are preferably dry fibre structures.

As the large area fibre structures are preferably very dense and tight i.e. are difficult to deform without damaging the fibre structure, these are usefully prepared as so-called fibre blanks or preforms e.g. in the form of hollow bodies or shell parts. These may be manufactured e.g. with the aid of an automatic preform unit in which the fibre blank is made in the shape exactly fitting the fibre-reinforced component.

The fibre preforms may e.g. be made using a deep drawing or stretch drawing process, whereby the fibre structures may be provided with a binder which becomes rigid on cooling the preform and keeps the preform in the shape given to it. The fibres are made into fibre-based preforms of the desired shape by fibre sliding effects, and if necessary by stretching. The fibre preforms may, however, be manufactured in a weaving process which allows three-dimensional fibre structures to be created.

Automated production of fibre preforms in preform units ensures close dimensional tolerances, high reproducibility and a high degree of automation.

The fibre preforms may also be produced as semi-dish shaped parts, whereby in this version—in one of the first steps for producing the fibre-reinforced component—a first fibre preform half shell is laid in the cavity followed by the core and covered over by a second corresponding fibre preform half shell. The fibre preform may also be in the form of a hollow body accommodating the core. The core is preferably completely enclosed in fibre structures or fibre preforms.

Before they are laid in the mould, the fibre preforms or fibre structures may be pre-wet in order to improve the infiltration of the plastic matrix during the injection process.

Apart from the above mentioned fibre preforms or fibre structures, further reinforcing fibres e.g. textile type, large area fibre structures in the form of layers or laminates may be provided in the fibre-reinforced component. Further, on its outer facing surface in the fibre-reinforced component the fibre preform or fibre structure may be covered over with an outer layer, which enables the fibre-reinforced component to be given a more attractive surface. Also, the fibre-reinforced component with closed or undercut space manufactured according to the invention may—for the purpose of locally increasing the stiffness and resistance to twisting and sagging—be produced in lengths with a sandwich type structure with reinforcing cores, in particular with foam cores of plastic. Apart from supporting cores, the mould may e.g. be fitted in regions with reinforcing cores. Preferred reinforcing cores are foam cores which may be made of polyurethane (PUR), polyvinylchloride (PVC) or a polyolefin. The reinforcing cores may be completely foamed when they are placed in the mould. The reinforcing cores may also be of a kind which, after being placed in the mould, foam out to their final shape during the production of the fibre-reinforced component. The foam core is usefully impervious to fluids. The foam cores may be of the partially or completely open pore type, preferably of the closed pore type, whereby these are e.g. Salted or closed off at their surface making them impervious to fluids. The reinforcing cores of foam exhibit a density e.g. of 30-100 kg/m³, preferably 60-80 kg/m³. The manner of introducing a reinforcing core into the mould cavity is the same as for a supporting core.

Further, inlays or inserts e.g. of metal, such as steel or aluminium, or of plastic may also be placed in the mould.

The mould is closed after it has been fitted with the above mentioned components. After that, the plastic matrix is injected into the cavity in the closed mould. The plastic matrix is e.g. made of a thermoplastic, preferably a duroplastic plastic. The plastic matrix injected into the mould is in particular a resin type system from the polymerisation resin series such as unsaturated polyester resins (UP) or methacrylates and in particular vinylester resins (VE), or from the polyaddition or poly-concensation resins such as epoxy resins, phenolic resins or poly-imides. Especially preferred are epoxy resin systems exhibiting extremely little shrinkage. This means that the resin system—in particular on hardening—exhibits no or only small changes in volume. The reaction shrinkage of the resin system preferably amounts to less than 3%.

The plastic matrix or the epoxy resin is preferably of low viscosity, easy to inject and preferably exhibits a viscosity of 100-500 mPa, in particular from 200 to 300 mPa.

The through-flow of resin is usefully in a cross-stream manner, whereby the feeding of the plastic matrix into the mould cavity may take place via one or more injection nozzles. The injection pressures are e.g. between 1 and 20 bar, preferably between 3 and 15 bar.

In a further version of the process according to the invention a negative pressure may be created in the mould cavity during the injection process in order to improve the flow of the resin and to remove the gases from the mould cavity faster.

The plastic matrix is preferably injected into the mould cavity at a temperature of at least 30° C., preferably at least 40° C. and in particular at least 55° C., and at most 80° C., preferably at most 75° C. and in particular at most 65° C.

During the injection process, the mould or the wall of the mould cavity is preferably heated to a temperature of at least 30° C., preferably at least 40° C. and in particular at least 50° C., and at most 80° C., preferably at most 70° C. and in particular at most 60° C.

The average temperature of the core during plastic deformation, the so-called forming temperature, and the average temperature of the core during the injection of the plastic matrix on production of the fibre-reinforced component, the so-called process temperature, are preferably the same or differ only slightly from each other. This ensures that, immediately after its plastic deformation, the core in the mould corresponds essentially to the condition of the mould and does not undergo any thermal change in volume.

The process temperature of the core is determined by the temperature of the core just prior to it being placed in the mould, by the temperature of the resin which is injected and by the temperature of the heated mould. The process temperature of the core deviates e.g. less than ±6° C., preferably less than ±4° C. and in particular less than ±2° C. from the temperature of deformation of the core.

In a further version of the invention the core process temperature is higher than its deformation temperature, e.g. more than 0° C., preferably more than 1° C., in particular more than 2° C., and less than 10° C., preferably less than 6° C., in particular less than 4° C. and advantageously less than 3° C. In a preferred version the core is heated, in particular by the heat of reaction released by the plastic matrix as it hardens. As a result of the heating, the core expands in the mould cavity and exerts pressure directed from the inside to the outside onto the reinforcing fibres and plastic matrix transverse to the layers of fibres i.e. onto the fibre composite mass, as a result of which the plastic matrix is pressed into the fibre mesh and the fibre meshes are completely penetrated by the plastic mass. The thermally induced change in volume of the core transverse to the fibre meshes amounts e.g. to more than 0%, preferably more than 1% and in particular more than 2%, and e.g. less than 10%, preferably less than 5%, in particular less than 3% of its original dimensions.

Due to this effect it is possible e.g. to produce fibre-reinforced components e.g. with a fibre content of over 40 vol. %, whereby the fibre-reinforced components achieve high quality surfaces.

Usefully, the fibre-reinforced components exhibit a volume fraction of fibres of more than 20%, preferably more than 30%, in particular over 40%, and usefully less than 80%, preferably less than 70%, in particular less than 60%.

After the injection process, the fibre-reinforced component is hardened in the mould preferably at a temperature of around 65-85° C., in particular 75-80° C. and removed from the mould when it has achieved stability of shape.

The mould occupation time, i.e. the duration from the charging to the removal of the fibre-reinforced component is e.g. less than 20 minutes, preferably less than 10 to 15 minutes.

After removal from the mould, the fibre-reinforced component is then subjected to so called tempering for which purpose the component is usefully transferred to a tempering mould. During tempering the fibre-reinforced component is heat treated for a period of e.g. several hours at temperatures of preferably 80-120° C., in particular 90-110° C., advantageously 95-105° C. During tempering the part obtains its permanent mechanical properties and appearance.

The tempering mould or the shell of the tempering mould forming the mould cavity is made e.g. of a metal or metal alloy such as aluminium or steel, a ceramic material and preferably of plastic or reinforced plastic. The tempering mould may be e.g. a pressure mould half.

The tempering is usefully carried out in a tempering oven in which the fibre-reinforced component is heated to the tempering temperature e.g. by thermal radiation, hot air or convection heating.

During tempering and in particular at the latest on reaching the maximum tempering temperature, the core is usefully melted out of the fibre-reinforced component, whereby at the completion of the tempering step the core has been completely melted out of the fibre-reinforced component. The tempering temperature and in particular the maximum tempering temperature, therefore, usefully corresponds to the temperature of melting of the core or higher.

Usefully, the fibre-reinforced component contains one or more suitably situated drainage openings, in particular in the form of holes or slits for the melted core material to run out. These drainage openings may be provided already during the production of the component or may be made subsequently in the component, e.g. as bored holes, after removal from the mould. The maximum diameter of the run-off openings is e.g. 1-50 mm, in particular 1 to 10 mm. The drainage openings are preferably as inconspicuous as possible i.e. not on important, visible surfaces.

The material of the melted core is usefully used to make a new core. In a preferred version of the invention, the melting out of the core takes place in a mould for manufacturing a new, preform of the kind described above. The drainage opening and filling opening may be connected to each other e.g. via a tube or pipeline. The melt of the core may e.g. flow into the mould—via a tube or pipeline connected up to the drainage outlet—whereby the tube or pipeline joins up with an inlet on the mould. By draining the melt off via a tube or pipeline one obtains a closed system, as a result of which excessive dispersion of vapours from the melt and hence deposition of condensate in the oven can be avoided or reduced.

The preform obtained from the melting out process directly from the melted core is again plastically shape-formed into a core. In a preferred version of the invention several preforms are kept in store and preforms are continually taken from store to manufacture the cores. The stocks of cores are continually made up of preforms from melted out cores, so that a balanced number of preforms is always on hand, thus allowing the production of fibre-reinforced to be increased at short notice. The shape-forming of the preforms into cores is advantageously adjusted with respect to the current number of fibre-reinforced components being produced. After shape-forming, the cores are advantageously fed directly to the production process.

The process according to the invention is suitable e.g. for manufacturing fibre-reinforced components for road and railway vehicles, for sports equipment and for fibre-reinforced components to be used in aircraft and aerospace applications, and for the building industry. The fibre-reinforced components may be e.g. space-frame parts, aerodynamic elements or spoilers (rear, front or roof spoilers), door elements such as door frames, or for tanks for storing fluids in road and rail vehicles, in particular private cars. Furthermore, the fibre-reinforced parts may be used as structural parts in the above mentioned areas.

The invention also relates to single part fibre-reinforced components manufactured using the process according to the invention. The fibre-reinforced components are characterised in that they exhibit a fibre content of more than 30% and at least one closed or undercut space, and the width of shape and dimensional tolerances, in particular the wall thickness is less than 5% with respect to a nominal value.

The wall thickness of a fibre-reinforced component manufactured according to the invention may be e.g. more than 1 mm, preferably more than 2 mm, in particular more than 3 mm and e.g. less than 30 mm, preferably less than 10 mm and in particular less than 6 mm.

The fibre-reinforced components manufactured according to the invention are characterised by way of high rigidity and structural strength in combination with low weight and, as a result of the use of plastic deformation of the supporting cores, close dimensional and shape tolerances, and excellent reproducibility. The width of dimensional and shape tolerances, in particular the wall thickness amount in total to less than 10%, preferably less than 5% and in particular less than 2% with respect to a nominal value. Furthermore, the visible surfaces of the fibre-reinforced components exhibit a “class A” surface finish. The inclusion of hollow spaces allows the integration of air ducts, conduits for current or fluids such as liquids or gases and for the storage of fluids.

The combination of a sandwich structure and integral hollow spaces allows components to be reinforced and stiffened in specific places and regions without having to increase the weight unnecessarily. In addition, it is possible to manufacture fibre-reinforced components according to the invention with a high degree of complexity in shape and integration of functions.

The process according to the invention for manufacturing supporting cores provides cores that are free of surface depressions and shrinkage. Also, the cores manufactured according to the invention exhibit excellent accuracy in dimensions with estimable shrinkage behaviour.

The invention is explained in greater detail by way of example and with reference to the accompanying drawings which show:

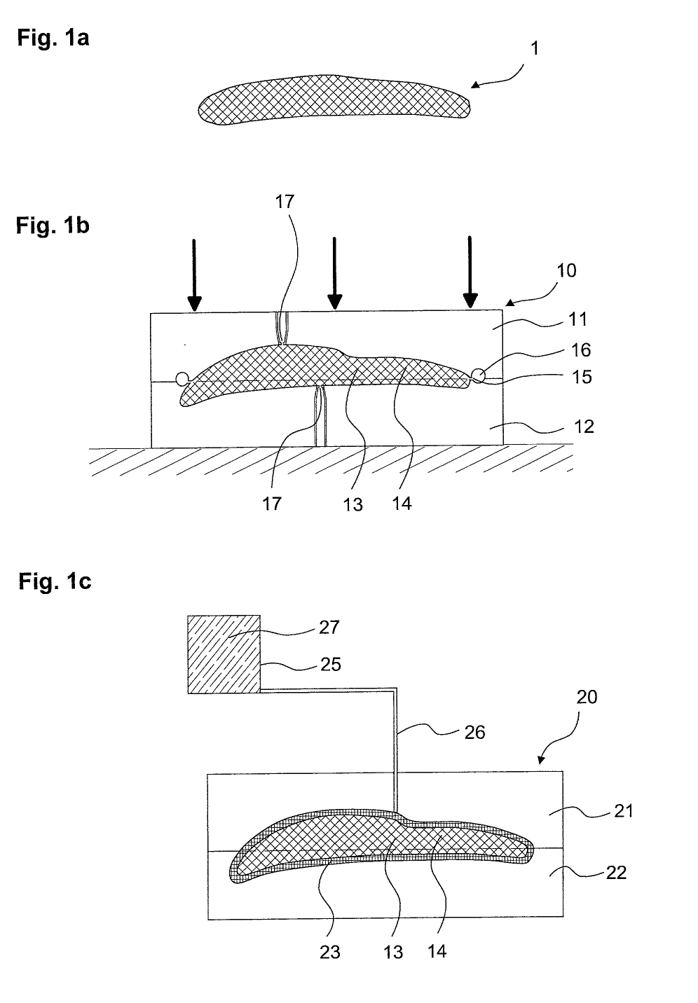

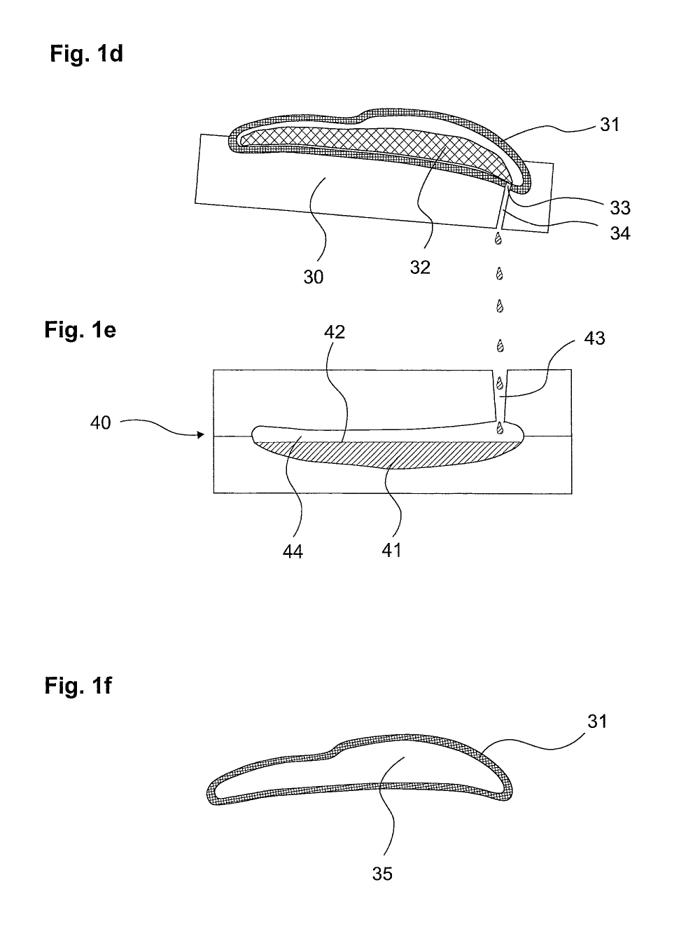

FIG. 1a: a schematic cross-sectional view of a preform made of wax;

FIG. 1b: a schematic cross-sectional view of a press-moulding tool with supporting core;

FIG. 1c: a schematic cross-sectional view of an RTM-mould containing the core and reinforcing fibres;

FIG. 1d: a schematic cross-sectional view of a fibre-reinforced component in the tempering mould;

FIG. 1e: a schematic cross-sectional view of a casting mould;

FIG. 1f: a schematic cross-sectional view of a fibre-reinforced component.

A preform 1 (FIG. 1a) in the rough shape of a supporting core 13 that is to be manufactured, made of a pure wax having a temperature of melting around 90° C. is heated to an average temperature of around 55° C. and laid in the cavity of the lower half 12 of a press-moulding tool 10 (FIG. 1b). The press-moulding tool 10, in particular the surface of the cavity 14 in the tool is warmed or heated to a temperature of around 60° C., so that the preform does not cool, or cools only insignificantly, during the shaping process. The plastic of the press-moulding tool 10 also insulates the preform, preventing it from cooling significantly.

By lowering an upper tool half 11 onto the lower tool half 12 and applying pressure in a controlled manner, the preform 1 is pressed or plastically deformed into the shape of the tool cavity 14. The forming into the shape of the final core 13 takes place by material flowing from regions with excess material to those regions of material deficit. Provided at suitable places in the tool 10 are degassing openings 17 which make it possible to remove trapped air pockets. The press-moulding tool 10 also features outlets 15 through which, during plastic deformation, excess preform material can flow out of the tool cavity 14 into a ring-shaped channel 16 running round the tool cavity 14. The pressing operation or deformation is complete with the closing of the tool 10.

After completion of the plastic deformation the tool 10 is opened by removing the upper half 11, and the supporting core 13 in its final shape can be removed from the tool cavity 14.

The core 13 is held at a temperature of around 55° C. and, after shape forming, employed for production of the fibre-reinforced component in the subsequent RTM process.

The fibre-reinforced component is manufactured in an RTM process. To that end a two-part, open RTM mould 20 is fed with fibre-reinforced preforms and the core 13 according to the invention, whereby the core 13 is surrounded by the fibre-reinforced preform (FIG. 1c). After the RTM mould 20 has been closed, i.e. after the upper and lower halves 21 and 22 of the RTM mould have been brought together, an epoxy resin matrix 27 is injected from a resin container 25 via resin pipeline 26 into the RTM mould cavity 24.

The epoxy resin matrix 27 is injected at a temperature of around 60° C. into the RTM mould, whereby the epoxy resin matrix soaks into the fibre preform producing a shaped fibre composite mass 23 which surrounds the core 13 like a shell.

After the injection process, the shaped fibre composite mass 23 is cured i.e. hardened at a reaction temperature of 65-85° C. Following that the fibre-reinforced component 31, which is already stable in shape, is removed from the RTM shaping tool 20 and transferred to a tempering mould 30 (FIG. 1d) for so called tempering. The tempering of the fibre-reinforced component 31 takes place in a suitable tempering oven (not shown here) at around 100-110° C.

During the tempering process the supporting core in the interior of the component 31 is melted and drained off, whereby the melt flows out, via a drainage opening 33 in the fibre-reinforced component 31 and via drainage channel 34 in the tempering mould 30. The melt flowing out is fed immediately to a casting mould 40 to form a new preform (FIG. 1e). The casting mould 40 forms a closed mould cavity 44, whereby the melt 41 is conducted into the mould cavity 44 via an inlet opening 43.

Deviating from the version presented here, it is also possible for the casting mould 40 to exhibit an open cavity, with the result that the preform produced exhibits a flat surface on one side corresponding to the original level 42 of the melt.

After tempering, the core has been fully melted and a completely hardened fibre-reinforced component 31 with hollow space 35 is obtained (FIG. 1f).

The preform 1 cast from the melted core material 13 is again plastically deformed to give a new supporting core 13.

1. Process for manufacturing single part fibre-reinforced components (31) having at least one closed or undercut space (35), in particular a Resin-Transfer-Moulding (RTM) process, whereby a shape-stable supporting core (13) to create the hollow space (35) in the fibre-reinforced component (31) is manufactured and a mould (20) with a cavity (24) is charged at least with fibre material and the supporting core (13), and a plastic matrix (27) capable of flowing is injected into the cavity (24) of the closed mould (20) soaking the fibre material and forming a shaped fibre-composite mass (23), and the fibre-composite mass (23) is hardened resulting in a fibre-reinforced component (31), characterised in that,
the supporting core (13) is a shaped part that can be melted out of the fibre-reinforced component (31) above room temperature and is manufactured by means of plastic deformation from a core mass or preform (1) and, in the process of manufacturing the fibre-reinforced component (31), the supporting core (13) is melted out of the fibre-reinforced component (31) when the component (31) has reached a stable shape containing a closed or undercut hollow space (35).

2. Process according to claim 1, characterised in that the supporting core (13) is plastically shape-formed out of a preform (1) and the preform (1) is preferably cast, in particular in a rough or approximate shape of the final supporting core (13), and the shape of the preform (1) is preferably chosen such that the distances the material has to flow during plastic shape-forming is as small as possible and the preform (1) has the same, and preferably a greater mass than the supporting core (13) to be manufactured.

3. Process according to one of the claims 1 to 2, characterised in that the core mass or the preform (19) is plastically shape-formed at an average temperature greater than 20° C., preferably greater than 35° C., in particular greater than 50° C. and less than the temperature of melting, whereby the temperature of melting lies above 50° C.

4. Process according to one of the claims 1 to 3, characterised in that the supporting core (13) contains wax, preferably natural, chemically modified or synthetic wax, and preferably is comprised essentially or completely thereof.

5. Process according to one of the claims 1 to 4 characterised in that the core mass or preform (1) exhibits a temperature of melting which is at least 75° C., preferably at least 85° C., and in particular at least 90° C. and at most 130° C., preferably at most 120° C. and in particular at most 110° C., and the core mass or preform (1) can be plastically formed from a temperature of at least 20° C., preferably of at least 30° C., in particular of at least 50° C. up to the temperature of melting.

6. Process according to one of the claims 1 to 5, characterised in that the supporting core (13) is manufactured via press-moulding and is shape-formed in a cavity (14) of a press-moulding tool, preferably in a press-moulding tool featuring a multi-part mould, in particular a two-part mould (10), whereby the core mass or preform (1) is laid in the open cavity (14) and, by bringing the mould parts (11, 12) together and closing the press-moulding tool, is pressed into the shape of the cavity (14) thus giving the supporting core (13) its final shape.

7. Process according to one of the claims 1 to 6, characterised in that the preform (1) is laid in an open two-part press-moulding tool (10) forming a tool cavity (14), whereby the press-moulding tool parts form cavity parts and the press-moulding tool cavity (14) makes up the hollow space in the fibre-reinforced component to be manufactured and, by closing the press-moulding tool (10), the core mass or preform (1) is pressed by shape-forming into the contour of the press-moulding tool cavity (14) and pressed to give a shaped supporting core (13).

8. Process according to one of the claims 1 to 7, characterised in that the core mass or preform (1) exhibits excess material with respect to the final, shaped supporting core (13) and the excess material is able to flow out of the cavity (14) via openings (15) during the press-mould forming and the cavity (14) contains degassing openings (17) to remove trapped pockets of air during the press-mould forming.

9. Process according to one of the claims 1 to 8, characterised in that a new preform (1) is formed out of the supporting core (13) material removed by melting, and the molten material from the supporting core (13) is led directly into a casting mould (40) in order to produce a new preform (1).

10. Process according to one of the claims 1 to 9, characterised in that the average temperature of the supporting core (13) during the injection of the plastic matrix (27) into the mould (20) deviates by less than ±6° C., preferably less than ±4° C., in particular less than ±2° C. from the average temperature of the core mass or preform (1) during the plastic deformation, or the average temperature of the supporting core (13) during the injection of the plastic matrix (27) into the moulding tool (20) corresponds to the average temperature of the core mass or preform (1) during the plastic deformation.

11. Process according to one of the claims 1 to 10, characterised in that the average temperature of the supporting core (13) during the injection of the plastic matrix (27) into the mould (20) is less than 6° C., preferably less than 4° C., in particular less than 3° C. and more than 0° C., preferably more than 1° C., in particular more than 2° C. higher than the average temperature of the core mass or preform (1) during its plastic deformation, whereby the supporting core (13), during or after the injection of the plastic matrix (27) is heated and a thermal volume expansion towards the fibre-composite mass (23) of more than 0%, preferably more than 1%, and less than 10%, preferably less than 5%, in particular less than 2% and, as a result of the thermal expansion in volume, pressure is exerted on the fibre-composite mass (23) which leads to the plastic matrix (27) effectively soaking into the fibre mass.

12. Process according to one of the claims 1 to 11, characterised in that the fibre-reinforced component (31) is produced in a Resin Transfer Moulding (RTM) process and the plastic matrix (27) is of a duromer system, particulary of a epoxy resin systems exhibiting little shrinkage, and the plastic matrix (27) is injected into the cavity (24) of a multi-part RTM-tool (20) at a temperature of about 60° C. and the plastic matrix (27) is hardened at a temperature of about 70-80° C. and the fibre-reinforced component (31) is subjected to a tempering process at a temperature of about 90-110° C. after removal from the mould and the supporting core (13) is melted out of the fibre-reinforced component (31) during the tempering process.

13. Process according to one of the claims 1 to 12, characterised in that the fibre masses are pre-formed fibre preforms of textile materials.

14. Process according to one of the claims 1 to 13, characterised in that the fibre masses are essentially of glass fibres.

15. Process for manufacturing a supporting core (13) for use in a process, in particular a Resin Transfer Moulding (RTM) process, for manufacturing fibre-reinforced components, characterised in that,
the supporting core (13) is a shaped body that can be melted at a temperature above room temperature and is manufactured from a core mass or a preform (1) by plastic deformation.

16. Process according to claim 15, characterised in that the supporting core (13) is plastically formed from a preform (1), and the preform (1) is preferably cast, in particular cast in a rough or approximate shape of the final supporting core (13), and the shape of the preform (1) is preferably chosen such that the distances that the material flows during plastic deformation are as short as possible, and the preform (1) is of a mass which is the same as or greater than that of the supporting core (13) to be produced.

17. Process according to one of the claims 15 to 16, characterised in that the core mass or preform (1) is plastically shape-formed at an average temperature greater than 20° C., preferably greater than 35° C., in particular greater than 50° C. and less than the temperature of melting, whereby the temperature of melting is above 50° C.

18. Process according to one of the claims 15 to 17, characterised in that the supporting core (13) contains wax, preferably natural, chemically modified or synthetic wax, and preferably is comprised essentially or completely thereof.

19. Process according to one of the claims 15 to 18, characterised in that the core mass or preform (1) exhibits a temperature of melting of at least 75° C., preferably at least 85° C. and in particular at least 90° C. and at most 130° C., preferably at most 120° C. and in particular at most 110° C., and the core mass or preform (1) can be plastically shape-formed from a temperature of at least 20° C., preferably at least 30° C., in particular at least 50° C. up to the melting point.

20. Process according to one of the claims 15 to 19, characterised in that the supporting core (13) is manufactured by press-moulding and is formed in a cavity (14) of a press-moulding tool, preferably in a press-moulding tool featuring a multi-part mould, in particular a two-part moulding tool (10), whereby the core mass or preform (1) is laid in the open cavity (14) and, by bringing the mould parts (11, 12) together and closing the press-moulding tool, is pressed into the shape of the cavity (14) thus giving the supporting core (13) its final shape.

21. Process according to one of the claims 15 to 20, characterised in that the preform (1) is laid in an open two-part press-moulding tool (10) forming a tool cavity (14), whereby the press-moulding tool parts form cavity parts and the press-moulding tool cavity (14) makes up the hollow space in the fibre-reinforced component to be manufactured and, by closing the press-moulding tool (10), the preform (1) is pressed by shape forming into the contour of the press-moulding tool cavity (14) and pressed to give a supporting core (13).

22. Process according to one of the claims 15 to 21, characterised in that the preform (1) features, with respect to the final shape of the supporting core (13), an overspill of material and, during plastic deformation, the overspill is able to flow out of the press-moulding tool cavity (14) via openings (15), and the press-moulding tool cavity (14) features degassing openings (17) for removing trapped pockets of air.

23. Device for manufacturing a supporting core according to claim 15, characterised in that,
the device is a two-part press-moulding tool (10) which, in the closed position, forms a cavity (14), and the cavity (14) reproduces the hollow space in the fibre-reinforced component (13) to be produced.

24. Device according to claim 23, characterised in that the press-moulding tool (10) contains degassing openings (17) for removing air from trapped air pockets and contains drainage openings (15) leading to drainage chambers (16) to drain off excess material from the preform (1) out of the tool cavity (14) during plastic shape-forming.

25. Single part fibre-reinforced components (31), manufactured using the process according to claim 1, characterised in that,
the fibre-reinforced components (31) exhibit a fibre content by volume of more than 30% and contain at least one closed or undercut space (35), and the span of shape and dimensional tolerances, in particular wall thicknesses, is less than 5% with reference to a nominal value.
